(19) United States
(12) Patent Application Publication
(10) Pub. No.: US 2024/0357428 A1
(43) Pub. Date: Oct. 24, 2024

(54) INFORMATION PROCESSING APPARATUS, INFORMATION PROCESSING METHOD, COMPUTER READABLE MEDIUM, AND WIRELESS COMMUNICATION SYSTEM

(71) Applicant: NEC Corporation, Minato-ku, Tokyo (JP)

(72) Inventors: Norifumi KAMIYA, Tokyo (JP); Mamoru SAWAHASHI, Tokyo (JP)

(73) Assignee: NEC Corporation, Minato-ku, Tokyo (JP)

(21) Appl. No.: 18/569,276

(22) PCT Filed: May 16, 2022
(86) PCT No.: PCT/JP2022/020365

§ 371 Date: Dec. 12, 2023

(30) Foreign Application Priority Data
Jun. 16, 2021 (JP) 2021-100001

(51) Int. Cl. H04W 28/18; H04W 16/26; H04W 72/0457

(52) U.S. Cl. CPC H04W 28/18; H04W 16/26; H04W 72/0457

(57) ABSTRACT

An information processing apparatus (10) includes: an acquisition unit (11) configured to acquire information regarding wireless communication of a back-haul link between a first base station (20A) and a second base station (20B) and information regarding wireless communication of an access link between the second base station and a user terminal; a control unit (12) configured to determine a first wireless communication method of the back-haul link and a second wireless communication method of the access link on the basis of the information acquired by the acquisition unit; and a transmission unit (13) configured to transmit information indicating the first wireless communication method determined by the control unit to at least one of the first base station or the second base station and transmit information indicating the second wireless communication method to at least one of the second base station or the user terminal.

### TECHNICAL FIELD

The present disclosure relates to an information processing apparatus, an information processing method, a program, and a wireless communication system.

### BACKGROUND ART

With the rapid spread of long term evolution (LTE) and LTE-Advanced, it is possible to provide a full-blown mobile broadband service. In order to cope with rapidly increasing traffic in the cellular network, in a 5th generation mobile communication system (5G), it is required to further increase the speed, capacity and frequency utilization efficiency as compared with LTE. In addition to an ultra-high speed and large capacity radio access network that implements a gigabit-class service for a user terminal (UE: user equipment), a further increase in speed and capacity of a back-haul between a base station and a serving-gateway (S-GW) of an evolved packet core (EPC) network is required. A back-haul link includes an E1/T1-specific line, an optical fiber network, a microwave wireless back-haul, and the like. The wireless back-haul has an advantage that a network cost can be reduced as compared with a wired back-haul.

FIG. 1 illustrates a configuration example of a HetNet (an example of a “wireless communication system 1”). In the example of FIG. 1, the HetNet 1 includes a macro cell base station (centralized base station) 20A, a small cell base station (relay base station) 20B, and a small cell base station 20C. Note that hereinafter, in a case where it is not necessary to distinguish the base stations such as the macro cell base station 20A, the small cell base station 20B, and the small cell base station 20C, they are also simply referred to as a “base station 20”. The coverage area of the macro cell base station 20A is referred to as a macro cell. In addition, the coverage areas of the small cell base station 20B and the small cell base station 20C are referred to as small cells. A heterogeneous network (HetNet) overlaying a small cell efficiently accommodating non-uniform traffic in a macro cell can accommodate non-uniform traffic in the macro cell in the network with high efficiency while ensuring a wide coverage area.

In the example of FIG. 1, the HetNet 1 includes a user terminal 30A, a user terminal 30B, and a user terminal 30C (hereinafter, in a case where it is not necessary to distinguish, they are also simply referred to as a “user terminal 30”). Note that the numbers of the base stations 20 and the user terminals 30 are not limited to the example of FIG. 1. The macro cell base station 20A and the small cell base station 20B are connected by a wireless back-haul N1. The small cell base station 20B and the small cell base station 20C are connected by a wireless back-haul N2. The macro cell base station 20A is connected so as to be able to communicate with a host station (core network) 40.

The macro cell ensures a coverage area for each user terminal 30 in the cell. A small cell is arranged in an area where traffic is high or the like in the macro cell and accommodates the traffic. A method using a frequency spectrum different from a method using the same frequency spectrum in a macro cell and a small cell has been proposed. In a case where different frequency spectrums are used for a macro cell and a small cell, different frequency spectrums are allocated such that the frequency spectrums of the macro cell and the small cell do not interfere with each other.

In a practical HetNet, a method using different frequency spectrums for a macro cell and a small cell is adopted. On the other hand, the method of using the same frequency spectrum in the macro cell and the small cell is effective from the viewpoint of frequency efficiency, but it is required to avoid interference between the macro cell and the small cell or between adjacent small cells. Since the transmission power of the macro cell is higher than that of the small cell, in cell search in which the user terminals 30A to 30C search for the cell site (base station) to which a radio link is connected, the reception power from the macro cell base station 20A is higher than the reception power from the cell site of the small cell located in the vicinity. In this regard, cell range expansion (CRE) is adopted which gives an offset to reference signal received power (RSRP), which is measured by the user terminals 30A to 30C, from the small cell base station 20B or 20C located in the vicinity, searches for the small cell base station, and connects a radio link. In addition, a method is also adopted which reduces interference given to a transmission signal from the small cell by providing the macro cell base station 20A with a subframe called almost blank subframe (ABS) for transmitting only a synchronization signal, control information, and a cell-specific reference signal (CRS).

In the HetNet, in order to perform efficient resource control including the avoidance of inter-cell interference between the macro cell and the small cell and between the small cells in the macro cell, a configuration in which the macro cell base station 20A is installed at a macro cell site and a remote radio device (remote radio equipment (RRE) or remote radio head (RRH)) is installed at a small cell site is effective. The macro cell base station 20A and the RRE are connected, with a transmission signal as a modulated baseband signal and a reception signal as a baseband signal before demodulation, by a high-speed optical fiber or a radio link. Since the processing of the physical layer and the upper layer of the small cell is performed in the macro cell base station 20A, centralized resource allocation including the small cell in the macro cell base station 20A is realized. In addition, from the viewpoint of installation cost and operation cost, a method of realizing connection between the macro cell base station 20A and the RRE by a radio link is effective.

In the third generation partnership project (3GPP (registered trademark)), a standard of integrated access and backhaul (IAB) in which a 5G new radio (NR) wireless interface using the same frequency spectrum is used for a back-haul link in addition to an access link has been formulated. FIG. 2 illustrates an example of a layer configuration and an interface of IAB. The macro cell base station 20A of an IAB donor and respective small cell base stations 20B and 20C of IAB nodes are connected by a back-haul link. The base station of the IAB node and the user terminal 30 are connected by an access link. The IAB donor base station is configured by a central unit (CU). The IAB node is configured by a distributed unit (DU). Here, Adaptation illustrated in FIG. 2 may also be referred to as backhaul adaptation protocol (BAP).

FIG. 3 illustrates a relationship between each node and a link in IAB. Centered on the central IAB node, an upper IAB parent node is an IAB donor, and a lower IAB node is an IAB child node. In addition, the central IAB node connects an access link with the user terminal 30. DL BH indicates a downlink back-haul link, and UL BH indicates an uplink back-haul link. The IAB node has a UL access function and a back-haul link function to the child IAB node. The resource allocation, that is, scheduling of downlink transmission of the IAB node is performed at the IAB node. For the downlink transmission, a back-haul link from the IAB node to the child IAB node and an access link from the IAB node to the user terminal 30 are used.

On the other hand, the scheduling of resource allocation of uplink transmission (a back-haul link from the IAB node to the parent IAB node or the IAB donor) of the IAB node is performed at the parent IAB node or the IAB donor. In the IAB of 3GPP, half duplex (HD) using time division multiplexing (TDM), frequency division multiplexing (FDM), and space division multiplexing (SDM) are supported for multiplexing access links and back-haul links. That is, full duplex (FD) in which the IAB node performs transmission and reception on the same resource block in the same time slot is not applied.

The back-haul link is mainly an optical fiber, but a microwave wireless back-haul is more advantageous than a wired back-haul from the viewpoint of installation cost and operation cost. In 3GPP, an integrated access and backhaul (IAB) wireless interface in which an NR wireless interface is extended to a back-haul link has been formulated. The IAB wireless interface can realize access links and back-haul links in the same frequency spectrum, and thus can provide an efficient service when applied to the HetNet. However, the IAB is a wireless interface based on a wireless interface for access links of Release 15 specification and extended to back-haul links between base stations. In the case of multi-antenna (multi-layer) transmission, orthogonal frequency division multiple access (OFDMA) is adopted for an uplink and a downlink. In addition, quadrature amplitude modulation (QAM) up to 256 values of rectangular signal space arrangement is adopted as a modulation scheme.

### CITATION LIST

### Non Patent Literature

### Non Patent Literature 1: 3GPP TR 38.874 Study on Integrated Access and Backhaul, V16.0.0 (2018-12).

Non Patent Literature 2: M. Polese, M. Giordani, T. Zugno, A. Roy, S. Goyal, D. Castor; and M. Zorzi, “Integrated Access and Backhaul in 5G mmWave Networks: Potential and Challenges,” IEEE Communications Magazine, vol. 58, no. 3, pp. 62-68, March 2020.
Non Patent Literature 3: C. Madapatha, B. Makki, C. Fang, O. Teyeb, E. Dahlman, M.-S. Alouini, and T. Svensson, “On Integrated Access and Backhaul Networks: Current Status and Potentials,” IEEE Open Journal of the Communications Society, Vol. 1, pp. 1374-1389 September 2020.
Non Patent Literature 4: M. Schnell and I. De Broeck, “Interleaved FDMA: equalization and coded performance in mobile radio applications,” 1999 IEEE International Conference on Communications, 1999.
Non Patent Literature 5: N. Maeda, Y. Kishiyama, H. Atarashi, and M. Sawahashi, “Variable Spreading Factor-OFCDM with Two Dimensional Spreading that Prioritizes Time Domain Spreading for Forward Link Broadband Wireless Access,” IEICE Trans. Commun., vol. E88-B, no. 2, pp. 487-498, February 2005.
Non Patent Literature 6: J. E. Mazo, “Faster-than-nyquist signaling,” The Bell System Technical Journal, vol. 54, no. 8, 1975.

### SUMMARY OF INVENTION

### Technical Problem

The IAB wireless interface is an extension of the NR wireless interface for access links to back-haul links and is not optimized for back-haul links, which are often considered to be in line-of-sight (LOS) environments.

The present disclosure has been made in view of such a point, and an object thereof is to provide a technology capable of more appropriately performing wireless communication.

### Solution to Problem

In a first aspect according to the present disclosure, an information processing apparatus includes: an acquisition unit configured to acquire information regarding wireless communication of a back-haul link between a first base station and a second base station and information regarding wireless communication of an access link between the second base station and a user terminal; a control unit configured to determine a first wireless communication method of the back-haul link and a second wireless communication method of the access link on the basis of the information acquired by the acquisition unit; and a transmission unit configured to transmit information indicating the first wireless communication method determined by the control unit to at least one of the first base station or the second base station, and transmit information indicating the second wireless communication method to at least one of the second base station or the user terminal.

In addition, according to a second aspect of the present disclosure, there is provided an information processing method including: acquiring information regarding wireless communication of a back-haul link between a first base station and a second base station and information regarding wireless communication of an access link between the second base station and a user terminal; determining a first wireless communication method of the back-haul link and a second wireless communication method of the access link on the basis of the acquired information; transmitting information indicating the determined first wireless communication method to at least one of the first base station or the second base station; and transmitting information indicating the second wireless communication method to at least one of the second base station or the user terminal.

In addition, in a third aspect according to the present disclosure, there is provided a program for causing an information processing apparatus to execute: processing of acquiring information regarding wireless communication of a back-haul link between a first base station and a second base station and information regarding wireless communication of an access link between the second base station and a user terminal; processing of determining a first wireless communication method of the back-haul link and a second wireless communication method of the access link on the basis of the acquired information; processing of transmitting information indicating the determined first wireless communication method to at least one of the first base station or the second base station; and processing of transmitting information indicating the second wireless communication method to at least one of the second base station or the user terminal.

In addition, in a fourth aspect according to the present disclosure, there is provided a wireless communication system including a first base station, a second base station, and a user terminal. The wireless communication system includes: an acquisition unit configured to acquire information regarding wireless communication of a back-haul link between the first base station and the second base station and information regarding wireless communication of an access link between the second base station and the user terminal; a control unit configured to determine a first wireless communication method of the back-haul link and a second wireless communication method of the access link on the basis of the information acquired by the acquisition unit; and a transmission unit configured to transmit information indicating the first wireless communication method determined by the control unit to at least one of the first base station or the second base station, and transmit information indicating the second wireless communication method to at least one of the second base station or the user terminal.

### Advantageous Effects of Invention

According to one aspect, wireless communication can be more appropriately performed.

### BRIEF DESCRIPTION OF DRAWINGS

FIG. 1 is a diagram illustrating a configuration example of a heterogeneous network (HetNet).

FIG. 2 is a diagram illustrating an example of a layer configuration and an interface of IAB.

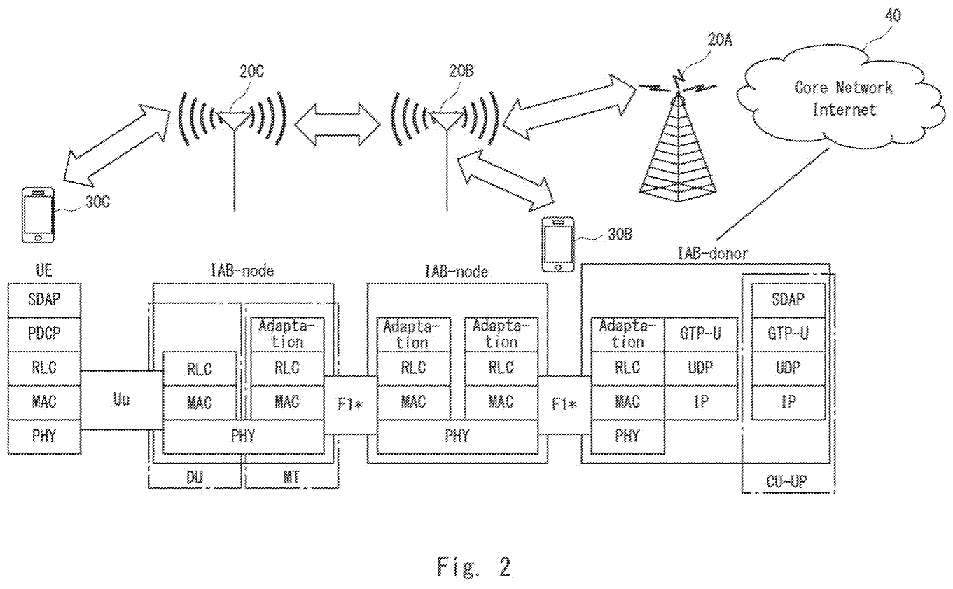

FIG. 3 is a diagram illustrating an example of a link of the IAB.

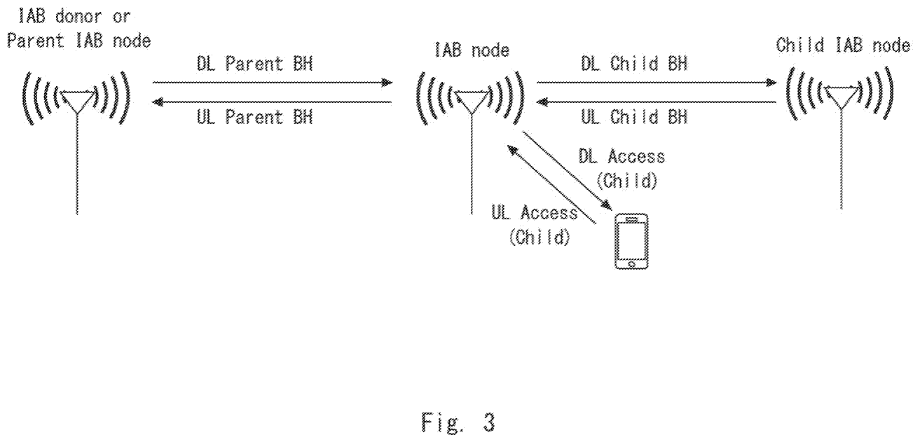

FIG. 4 is a diagram illustrating a configuration example of an information processing apparatus according to an example embodiment.

FIG. 5 is a flowchart illustrating an example of processing of the information processing apparatus according to the example embodiment.

FIG. 6 is a diagram illustrating an example of processing of selecting single-carrier FDMA and OFDMA according to the example embodiment.

FIG. 7 is a diagram illustrating an example of processing of adaptively controlling a coding rate and signal space arrangement according to the example embodiment.

FIG. 8 is a diagram illustrating an example of a multiplexing method of a reference signal in OFDMA according to the example embodiment.

FIG. 9 is a diagram illustrating an example of a multiplexing method of a reference signal in single-carrier FDMA according to the example embodiment.

FIG. 10 is a diagram illustrating an example of processing of adaptively controlling a multiplexing method of control information in a case where OFDMA according to the example embodiment is used.

FIG. 11 is a diagram illustrating an example of processing of adaptively controlling a multiplexing method of control information in a case where DFT-spread OFDM according to the example embodiment is used.

FIG. 12 is a diagram illustrating an example of processing of adaptively controlling a multiplexing method of control information in a case where DFT-spread OFDM according to the example embodiment is used.

FIG. 13 is a diagram illustrating an example of a transmission frame configuration in a case where Faster-than-Nyquist (FTN) according to the example embodiment is used.

FIG. 14 is a flowchart illustrating an example of uplink resource allocation processing of access links according to the example embodiment.

FIG. 15 is a flowchart illustrating an example of downlink resource allocation processing of access links according to the example embodiment.

FIG. 16 is a diagram illustrating a configuration example of an information processing apparatus according to an example embodiment.

### EXAMPLE EMBODIMENT

The principles of the present disclosure will be described with reference to several exemplary example embodiments. It is to be understood that these example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present description have the same meaning as commonly understood by those skilled in the art of the technical field to which the present disclosure belongs.

Hereinafter, example embodiments of the present invention will be described with reference to the drawings.

### Configuration

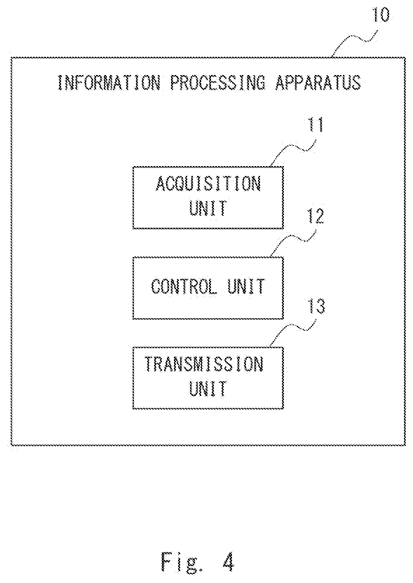

FIG. 4 is a diagram illustrating a configuration example of an information processing apparatus 10 according to an example embodiment. In FIG. 4, the information processing apparatus 10 includes an acquisition unit 11, a control unit 12, and a transmission unit 13. Note that the configuration illustrated in FIG. 4 is merely an example. The name of each unit may be any name as long as the processing of the present disclosure can be executed.

The acquisition unit 11 acquires various types of information from a storage device inside the information processing apparatus 10 and an external apparatus. For example, the acquisition unit 11 acquires information regarding wireless communication of back-haul links between a macro cell base station and small cell base stations overlaid in macro cells of the macro cell base station. In addition, the acquisition unit 11 acquires, for example, information regarding wireless communication of an access link between at least one of the macro cell base station and the small cell base stations and a user terminal.

The control unit 12 performs various types of control. For example, the control unit 12 determines a first wireless communication method of back-haul links and a second wireless communication method of access links on the basis of the information acquired by the acquisition unit 11.

The transmission unit 13 transmits (outputs) various types of information in accordance with an instruction from the control unit 12. For example, the transmission unit 13 transmits information indicating the first wireless communication method determined by the control unit 12 to at least one of the macro cell base station and the small cell base stations, and transmits information indicating the second wireless communication method to at least one of the macro cell base station, the small cell base stations, and the user terminal. Accordingly, wireless communication can be more appropriately performed.

### System Configuration

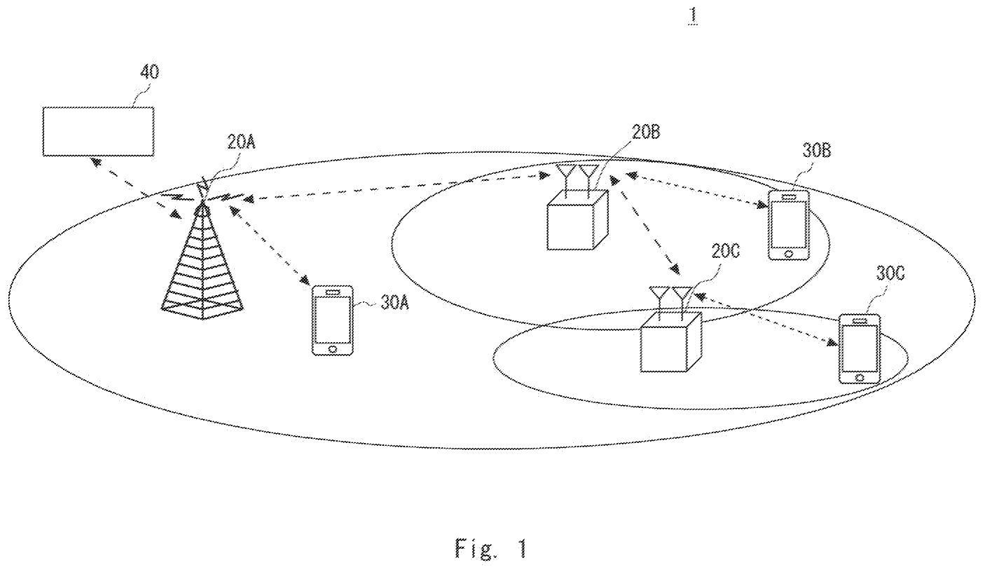

The system configuration of the wireless communication system 1 according to the example embodiment may be similar to that of a heterogeneous network (HetNet) in FIG. 1. In this case, the information processing apparatus 10 may be provided, for example, in an apparatus such as a macro cell base station 20A, a small cell base station 20B, or a small cell base station 20C forming a heterogeneous network (HetNet) illustrated in FIG. 1, or in a host station 40. In addition, the information processing apparatus 10 according to the example embodiment may be provided as a separate apparatus outside apparatuses such as the host station 40, the macro cell base station 20A, and the small cell base station illustrated in FIG. 1, for example. Note that the numbers of the base stations 20 and user terminals 30 are not limited to the example of FIG. 1.

Note that in the heterogeneous network according to the example embodiment, the small cell base station 20B and the like may be arranged in the coverage area of the macro cell base station 20A. In this case, the small cell base station 20B or the like may be installed at a position to have, as the coverage area, an area where the traffic of wireless communication is relatively high within the coverage area of the macro cell base station 20A. In addition, in the heterogeneous network according to the example embodiment, a back-haul link between the base stations and an access link between the base station and the user terminal may perform wireless communication using the same or different frequency spectrums.

The base station 20 and the user terminal 30 are connected so as to be able to communicate by, for example, wireless communication such as a 5th generation mobile communication system (5G), a Beyond 5G, a 4th generation mobile communication system (4G), or a wireless local area network (LAN).

Note that the term “base station (BS)” used in the present disclosure refers to a device that can provide (host) a coverage area (cell) in which the user terminal 30 can communicate. Examples of the base station 20 include, but are not limited to, a Node B (or NB), an evolved Node B (eNode B or eNB), a next generation Node B (gNB), a remote radio unit (RRU), a radio head (RH), a remote radio head (RRH), a low power node (for example, femto node, pico node), and the like.

The term “user terminal (UE: user equipment)” used in the present disclosure refers to any device having a wireless or wired communication function. Examples of the user terminal 30 include, but are not limited to, a smartphone, a cellular phone, a mobile phone, an Internet of Things (IoT) device, a personal computer, a desktop, a personal digital assistant (PDA), a portable computer, an image capture device such as a digital camera, a game device, a music storage and playback equipment, or Internet equipment that enables Internet access, browsing, and the like.

The communications described in the present disclosure may conform to any suitable standard including, but not limited to, Beyond 5G, 5G (NR: New Radio), 4G (LTE-Advanced, WiMAX2), Long Term Evolution (LTE), wideband code division multiple access (W-CDMA), code division multiple access (CDMA), Global System for Mobile Communications (GSM: Global System for Mobile), and the like. Further, communication may be executed in accordance with any generation of communication protocols now known or developed in the future.

In addition to normal data communication, the base station 20 may transmit a downlink reference signal (RS) to the user terminal 30 in broadcast, multicast, and unicast manners. Similarly, the user terminal 30 may transmit the RS to the base station 20 on the uplink. As used in the present description, “downlink” refers to a link from the macro cell base station 20A toward the user terminal 30, and “uplink” refers to a link from the user terminal 30 toward the macro cell base station 20A.

For example, the RS of downlink is used by the user terminal 30 for beam sweeping, channel estimation, demodulation, and other operations for communication. In general, the RS is a signal sequence (also referred to as an “RS sequence”) known by both the base station 20 and the user terminal 30. For example, the RS sequence is generated and transmitted by the base station 20 on the basis of a certain rule, and the user terminal 30 estimates the RS sequence on the basis of the same rule. Examples of the RS include, but are not limited to, a de-modulation reference signal (DM-RS) which is a reference signal for performing demodulation on a downlink or uplink receiving side, a channel state information-reference signal (CSI-RS) which is a reference signal to be transmitted for measuring a state of a radio channel on a receiving side, a sounding reference signal (SRS), a phase tracking reference signal (PTRS), a fine time, a frequency tracking reference signal (TRS), and the like.

### Processing

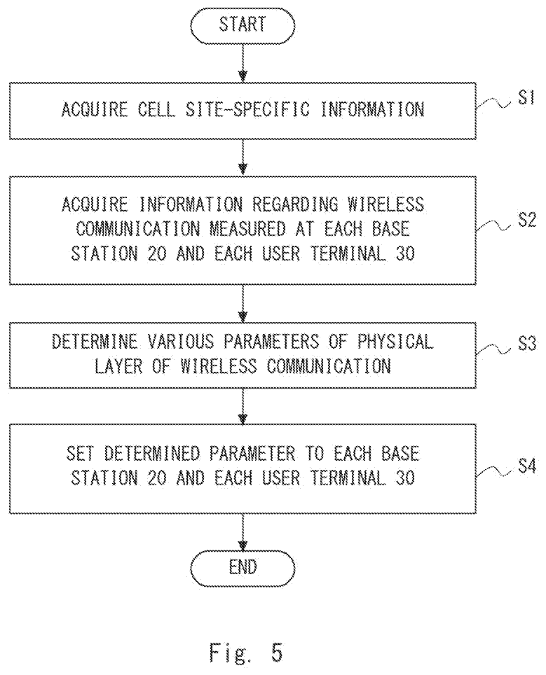

Next, an example of processing of the information processing apparatus 10 according to the example embodiment will be described with reference to FIG. 5. FIG. 5 is a flowchart illustrating an example of processing of the information processing apparatus 10 according to the example embodiment.

In step S1, the acquisition unit 11 of the information processing apparatus 10 acquires information (hereinafter, also appropriately referred to as “cell site-specific information”) specific to each base station 20 from a storage unit inside or outside the information processing apparatus 10 or each base station 20. Note that the cell site-specific information may be measured when the base station 20 is installed. In addition, the measurement (update) may be performed again when a new base station 20 is installed.

The following processing may be executed, for example, when the radio link is set up in order for the user terminal 30 to start communication. In addition, the processing may also be executed when the degree of change in the information regarding the wireless communication measured in each base station 20 and each user terminal 30 is equal to or greater than a threshold value.

For each link type, the cell site-specific information may include, for example, at least one of one or more frequency spectra that can be used by the base station 20 in wireless communication and information indicating the size (range, magnitude) of the coverage area of the base station 20. In addition, the cell site-specific information may include, for example, information (for example, a propagation loss between base stations) indicating a distance (for example, an inter-cell site distance, a distance between the centers of cells) between one base station 20 and another surrounding base station 20. In addition, for each link type, the cell site-specific information may include, for example, information indicating a distribution of traffic between the cell of one base station 20 and the cell of another surrounding base station 20. In addition, the cell site-specific information may include, for example, information indicating a peak-to-average power ratio (PAPR) or the like of the transmission signal for each link type.

The link type is the type of a link to which the base station 20 allocates a resource of wireless communication. The link type may include the uplink of a back-haul link, the downlink of a back-haul link, the uplink of an access link, and the downlink of an access link. Note that, in the base station 20, an identifier (PCID) of a physical cell of another surrounding base station 20 and a link type are set in association with each other.

One or more frequency spectra that can be used by the base station 20 in wireless communication may be set in advance in the relevant base station 20. Note that distance attenuation (variation in a long section) can be estimated from the distance attenuation formula on the basis of each frequency spectrum that can be used by the base station 20 in wireless communication.

Information on the size (cell radius) of the coverage area of the base station 20 may be stored in advance in the relevant base station 20. Information on a distance between one base station 20 and another surrounding base station 20 may be stored in advance in the one base station 20.

A PAPR for each modulation scheme with respect to the number of subcarriers of the transmission signal can be calculated from the transmission bandwidth of OFDM. In addition, the PAPR varies depending on the roll-off rate of a waveform shaping filter using a root raised cosine filter. Therefore, for single-carrier FDMA and OFDM having different numbers of subcarriers in the transmission band, the information processing apparatus 10 may calculate and table (store) the PAPR for the modulation scheme and the roll-off rate of the waveform shaping filter in advance.

Subsequently, the acquisition unit 11 of the information processing apparatus 10 acquires information regarding wireless communication measured at each base station 20 and each user terminal 30 (step S2). Note that, when the wireless communication is connected (online), each base station 20 and each user terminal 30 measure the information regarding the wireless communication by using a reference signal at a predetermined cycle, for example, and transmit the measured information to the information processing apparatus 10. The information regarding the wireless communication may include, for example, information regarding phase noise of a transmitter and a receiver, a power delay profile (LOS/NLOS), and the moving speed of the user terminal 30.

Note that, for the phase noise of the transmitter and the receiver, in a high frequency spectrum in a millimeter wave band, the phase noise caused by frequency fluctuation of a local oscillator using a phase locked loop (PLL) is one of main characteristic degradation factors. The phase noise of the local oscillator occurs due to a reference clock signal (reference clock), the noise of a PLL element, and a voltage controlled oscillator (VCO). The power spectrum density (PSD) of the phase noise caused by the reference clock signal has a frequency characteristic of attenuation in the second order of a frequency f (1/f², and note that, here, “/” represents a division) and 20 dB/decade (every time the frequency becomes 10 times, the amplitude of the passing signal attenuates by 20 dB).

The PSD of the phase noise caused by the elements of the PLL has a frequency characteristic of attenuation in the first order of the frequency f (1/f, and note that, here, “/” represents a division) and 10 dB/decade. The PSD of the phase noise caused by the VCO includes a phase noise having a frequency characteristic of attenuation in the second order of frequency (1/f², and note that, here, “/” represents a division) and 20 dB/decade and a phase noise having a frequency characteristic of attenuation in the third order (1/f³, and note that, here, “/” represents a division) and 30 dB/decades. It is reported that the phase noise caused by the reference clock signal and the element of the PLL is dominant at a frequency lower than the loop band of the PLL, and the phase noise caused by two types of VCOs is dominant at a frequency higher than the loop band of the PLL.

Note that each base station 20 and each user terminal 30 may calculate the power of the phase noise using the reference signal. In addition, each base station 20 and each user terminal 30 may calculate the power of the phase noise on the basis of the power spectrum density (PSD) of the phase noise of the local oscillator using the PLL frequency synthesizer.

The power delay profile (LOS/NLOS) may be measured, for example, by using a reference signal. Note that the reception power of the direct wave, the Rician factor, the root mean square (rms) delay spread, the delay time of the maximum path, and the like can be measured on the basis of the power delay profile. It is possible to identify whether the channel is a LOS channel, an NLOS channel, or a LOS/NLOS mixed channel by the received power of the direct wave. The moving speed of the user terminal 30 may be calculated, for example, on the basis of the Doppler frequency measured by using the reference signal.

Subsequently, the control unit 12 of the information processing apparatus determines various parameters of the physical layer of the wireless communication of the back-haul link and the access link on the basis of the information acquired by the acquisition unit 11 (step S3). Here, the information processing apparatus 10 may determine various parameters of wireless communication to be applied to each base station 20 and each user terminal 30 on the basis of, for example, the cell site-specific information acquired in step S1, the information regarding the wireless communication acquired in step S2, and traffic requirement. The traffic requirements may include, for example, requirements such as a delay (transmission delay), an error rate, and a data rate. The traffic requirement may be designated from the user terminal 30, for example. In addition, the traffic requirement may be set in each base station 20, for example.

Subsequently, the transmission unit 13 of the information processing apparatus 10 transmits the determined parameter to each base station 20 and each user terminal 30 (step S4). Accordingly, various parameters of more appropriate wireless communication can be applied to each apparatus.

Hereinafter, an example of processing of determining various parameters of the wireless communication in step S3 will be described. Note that the following types of processing can be executed in appropriate combination.

### Example of Adaptively Controlling Physical Channel Multiplexing Scheme (Waveform)

The information processing apparatus 10 may adaptively determine a physical channel multiplexing scheme (Waveform) on the basis of the acquired information. In this case, for the back-haul link, in a case where the frequency spectrum to be used is higher than a threshold value and a distance between base stations is longer than a threshold value, the information processing apparatus 10 may select discrete Fourier transform (DFT)-spread OFDM (an example of single-carrier FDMA) as the physical channel multiplexing scheme. Accordingly, for example, the wireless communication of the back-haul link in the LOS environment having a relatively large propagation loss can be appropriately executed.

In addition, for the back-haul link, in a case where a distance between the macro cell base station 20 and the small cell base station 20 is shorter than a threshold value, and the power of the multipath signal caused by reflection and scattering from surrounding features and buildings in addition to the direct wave is higher than a threshold value, the information processing apparatus 10 may select OFDMA as the physical channel multiplexing scheme.

In addition, in the access link, in a case where the applied frequency spectrum is higher than a threshold value and is larger than a size threshold value of the coverage area (the cell radius is larger than the threshold value), the information processing apparatus 10 may select DFT-spread OFDM as the physical channel multiplexing scheme. In addition, in other cases, the information processing apparatus 10 may select OFDMA in the access link.

Note that a typical propagation environment for wireless back-haul is line-of-sight (LOS) propagation. In a wireless back-haul link of a practical system, super multi-level modulation, polarization multi-input multi-output (MIMO), and LOS-MIMO are applied in order to increase the speed and the capacity. On the other hand, in the NR wireless interface, in a case where multi-antenna MIMO is used, OFDMA is adopted in both the uplink and the downlink. Therefore, in the IAB wireless interface, OFDMA is used in both the uplink and the downlink including the back-haul link. However, OFDMA has a disadvantage that compared to single-carrier FDMA, PAPR is higher, and resistance to phase noise is weak. Therefore, the transmission backoff of the power amplifier of the transmitter limits a distance between the base stations that can provide a service. On the other hand, according to the present disclosure, it is possible to reduce the limitation of the distance between the base stations that can provide the service. Therefore, wireless communication can be more appropriately performed.

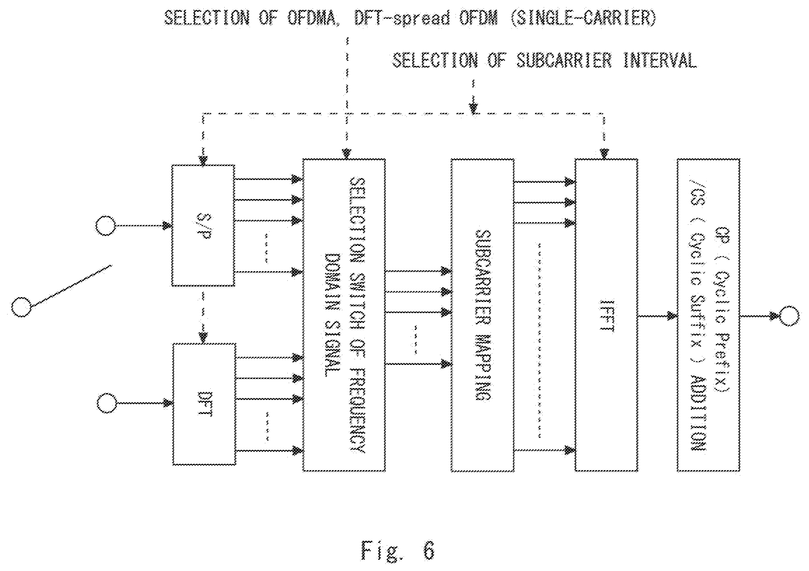

FIG. 6 is a diagram illustrating an example of processing of selecting single-carrier FDMA and OFDMA according to the example embodiment. In the example of FIG. 6, the information processing apparatus 10 first converts a single-carrier FDMA signal into a frequency domain by discrete Fourier transform (DFT). Then, the information processing apparatus 10 generates each frequency component (corresponding to a subcarrier of OFDMA) in the frequency domain by using DFT-spread OFDM that performs mapping to allocated frequency components. By replacing the series/parallel (S/P) conversion processing of OFDMA with DFT, generation of the single-carrier FDMA signal and the OFDMA signal can be easily switched.

In a case where OFDMA is selected, the information processing apparatus 10 may use the spread in the frequency domain in a case where the delay spread is large, that is, in a case where the frequency selectivity is large. In addition, in a case where the Doppler frequency measured by the user terminal 30 is higher than a threshold value, the information processing apparatus 10 may use spread in a time domain. Accordingly, for example, since the moving speed of the user terminal 30 is relatively high, a time diversity effect can be obtained in a case where amplitude and movement variation in a slot section including a plurality of OFDM symbols are large. In this case, the information processing apparatus 10 may perform two-dimensional spreading in the frequency and time domains by using the two-dimensional Walsh-Hadamard code allocation method proposed in Non Patent Literature 5.

### Example of Controlling Coding Rate of Channel Coding and Signal Space Arrangement of Mapping Bits after Channel Coding

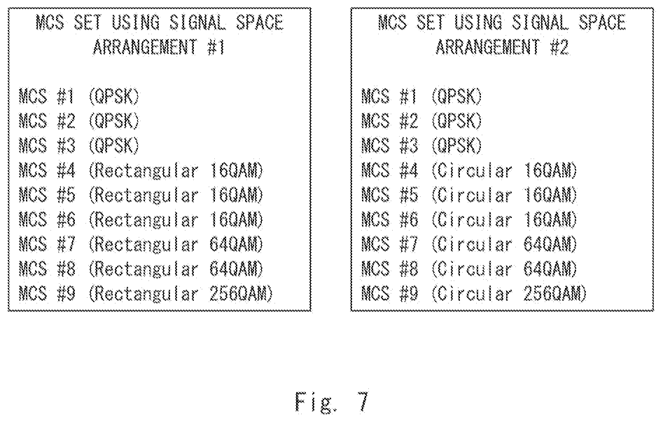

FIG. 7 is a diagram illustrating an example of processing of adaptively controlling a coding rate and a signal space arrangement according to the example embodiment. The information processing apparatus 10 may determine at least one of a set of coding rates of channel coding and a set of signal space arrangements of mapping bits after channel coding on the basis of the acquired information. In this case, as illustrated in FIG. 7, the information processing apparatus 10 may set in advance a signal space arrangement set having a plurality of modulation multilevel numbers (the number of signal points in the signal space arrangement) for different signal space arrangements. In this case, the information processing apparatus 10 may prepare the modulation multilevel number such as binary phase-shift keying (BPSK), quadrature phase shift keying (QPSK), 16 QAM, 64 QAM, 256 QAM, and 1024 QAM as an example. The user terminal 30 may use, as the type of signal space arrangement, a Rectangular/Cross QAM signal space arrangement adopted in a practical cellular system, a Circular QAM signal space arrangement including a plurality of concentric circles having different radii, or the like. Then, the information processing apparatus 10 may set the above-described various signal space arrangements corresponding to signal multilevel numbers for respective signal space arrangements. Note that the Circular QAM signal space arrangement has different resistance to PAPR and phase noise depending on the number of rings and the number of signal points on the ring. Therefore, the information processing apparatus 10 may set different Circular QAM signal space arrangements according to the same modulation multilevel number.

The information processing apparatus 10 may select a signal space arrangement set from a plurality of signal space arrangement sets on the basis of the cell site-specific information and the phase noise of the transmitter and the receiver. Then, the information processing apparatus 10 performs adaptive rate control on the selected signal space arrangement set by dynamically (adaptively) selecting a modulation scheme (modulation multilevel number) and a coding rate of channel coding (MCS, Modulation and Coding Scheme) according to a received SNR for each transmission time interval (TTI).

Note that, in the NR wireless interface, a Recuangular QAM signal space arrangement is adopted. For thermal noise and interference, the Rectangular QAM signal space arrangement capable of maximizing the Euclidean distance between signal points can realize the best error rate. However, in the 5G and Beyond 5G systems, application of a frequency spectrum up to about 100 GHz is assumed. In the future, a frequency spectrum of 100 GHz or more is also targeted.

Due to the large propagation loss in the high frequency spectrum of the millimeter waveband, the Rectangular QAM signal space arrangement having a high PAPR necessarily increases the transmission backoff of the power amplifier of the transmitter. In addition, in the frequency spectrum of the millimeter wave band, the most main factor of error rate degradation is the phase noise caused by frequency fluctuation of the local oscillator. The Rectangular QAM signal space arrangement is less resistant to the phase noise. On the other hand, according to the present disclosure, the resistance to phase noise can be improved. Therefore, wireless communication can be more appropriately performed.

Note that, for Gaussian noise and interference, the Rectangular signal space arrangement having the largest Euclid between signal points can reduce the required reception SNR the most. In a case where the number of signal points is 2^{2k+1} (k is an integer of 1 or more), the signal space arrangement does not become a square but becomes a cross shape, and thus is called Cross QAM. The Rectangular QAM can perform gray mapping, but the Cross QAM cannot perform the gray mapping on all the signal points since the signal point of the corner is missing and becomes pseudo gray mapping. Since the Rectangular/Cross QAM signal space arrangement has an azimuth between signal points, the resistance to phase noise that causes only phase variation is not strong. In addition, since a difference between the minimum amplitude and the maximum amplitude is large in the Rectangular/Cross QAM, high peak power is generated when the band is limited by the root raised cosine filter. On the other hand, the Circular QAM having the concentric signal space arrangement can make an azimuth between adjacent signal points on the same ring larger than that of the Rectangular/Cross QAM, so that the resistance to phase noise is high. In addition, in the Circular QAM, bits indicating amplitude components and phase components can be mapped independently. The amplitude ratio of the concentric circle can be set independently of the azimuth. In particular, in the signal space arrangement in which the same number of signal points having the same phase are arranged on different concentric circles, in a case where signal points having the same phase on adjacent concentric circles are erroneously decoded, only the amplitude information is erroneously decoded, and thus, the amplitude bit in which the error has occurred can be often corrected by the coding gain of the error correction coding (channel coding). Therefore, an interval between adjacent concentric circles can be shortened, and an interval between the innermost concentric circle and the outermost concentric circle can be narrowed. As a result, the PAPR can be suppressed to be low compared to the Rectangular/Cross QAM. In addition, a phase margin can be increased by aligning the phases of signal points in a plurality of different concentric circles. Therefore, the resistance to phase noise can be increased as compared with the Rectangular/Cross QAM.

In addition, phase noise is estimated by using reference signal symbols obtained by performing multiplexing on information symbols in the time domain at regular intervals. When the transmission signal of the reference signal is represented by s(l) (l represents the index of the reference signal symbol), a reception signal r(l) is represented by the following Expression (1). Here, θ represents phase noise, and w represents thermal noise.

$$\begin{matrix}[ Math . 1 ] & \\ r ( l ) = s ( l ) {e}^{j θ ( l )} + w ( l ) & ( 1 )\end{matrix}$$

Therefore, the information processing apparatus 10 can estimate a phase noise term by the following Expression (2) by multiplying the reception signal by the complex conjugate of the reference signal. Here, * represents a complex conjugate.

$$\begin{matrix}[ Math . 2 ] & \\ {e}^{j \hat{θ} ( l )} = r ( l ) {s ( l )}^{*} & ( 2 )\end{matrix}$$

However, noise components such as receiver noise and background noise are added to the estimated phase noise. Therefore, the information processing apparatus 10 may average the phase noise estimated by a plurality of reference signal symbols in order to remove the noise components. In this case, it is required to average the phase noise estimation values of the reference signal symbols in a range in which the correlation of the phase noise in the time domain is high. Therefore, the information processing apparatus 10 may use a method of estimating the estimated value of the phase noise in a preset time section by a moving average, a method using a Wiener filter, or the like.

In addition, the information processing apparatus 10 can estimate the phase noise with high accuracy by using the determined information symbol in addition to the reference signal symbols. Specifically, the phase noise may be estimated by phase locked loop (PLL) phase noise estimation using a determination bit before or after error correction coding (channel coding) decoding. In this case, the information processing apparatus 10 can generate a highly accurate determination feedback symbol using the coding gain of the error correction code by using the determination bit after the error correction decoding.

### Example of Adaptively Controlling Multiplexing Method of Reference Signal (Pilot Signal)

A reference signal is required to estimate channel response for equalization weight generation of multipath fading channels, to estimate the phase noise, to estimate channel quality indicator (CQI), and to estimate channel state information (CSI). In the NR wireless interface, a demodulation reference signal (DM-RS), a CSI measurement reference signal (CSI-RS), and a phase noise measurement reference signal (PT-RS: Phase Tracking RS) are adopted. The reference signal of the NR wireless interface is configured on the premise of the waveform of OFDMA, and only a multiplexing method of the reference signal according to the number of transmission antennas is defined.

As described above, the information processing apparatus 10 according to the example embodiment of the present disclosure may adaptively select OFDMA, DFT-spread OFDM, or the like as physical channel multiplexing scheme (Waveform). In this case, the information processing apparatus 10 may control a multiplexing method of a channel state information (CSI)-RS for measuring the reception quality and a demodulation (DM)-RS for demodulation used for synchronous detection according to the selected physical channel multiplexing scheme.

In addition, the information processing apparatus 10 may adaptively control the multiplexing method and the multiplexing interval of the phase tracking reference signal (PT-RS) on the basis of the phase noise measured in each base station 20 and each user terminal 30 and the information indicating the power delay profile (frequency offset).

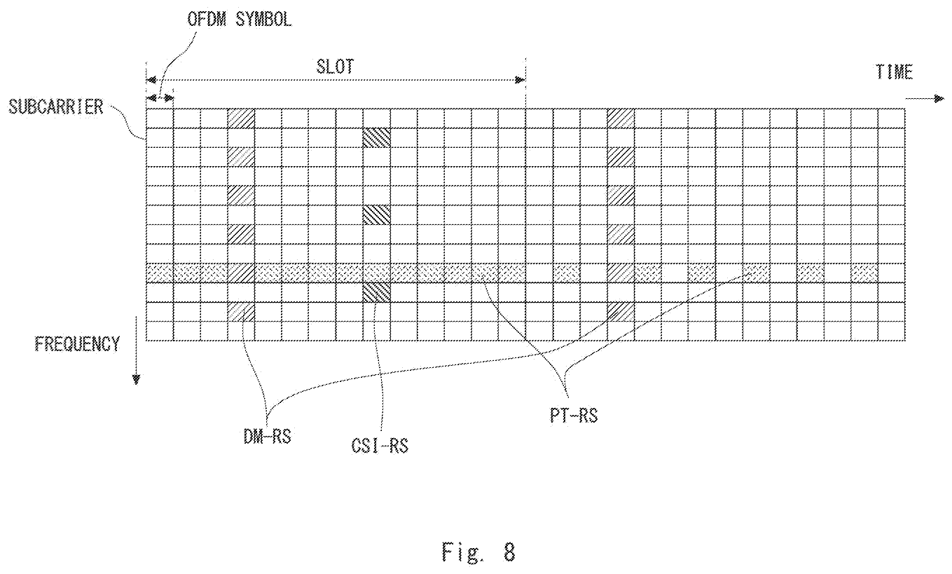

FIG. 8 is a diagram illustrating an example of the multiplexing method of the reference signal in OFDMA according to the example embodiment. The reference signal multiplexing method illustrated in FIG. 8 is based on the reference signal multiplexing method of an NR wireless standard. The multiplexing method of the CSI-RS and the DM-RS in the case of using OFDMA of the present disclosure may be similar to the NR wireless interface. Note that, in the NR wireless interface, phase tracking (PT)-RS for phase noise and frequency offset estimation is adopted in addition to the CSI-RS and the DM-RS. The DM-RS defines orthogonal reference signals using frequency division multiplexing (FDM) and code division multiplexing (CDM) according to the number of transmission antennas used for MIMO multiplexing. The PT-RS is sparsely multiplexed in the frequency domain. The time domain is multiplexed every 4, 2, and 1 OFDM symbols according to the MCS. In a low MCS such as QPSK, the influence of the phase noise is small, and thus the insertion loss of the reference signal can be suppressed to be low by multiplexing the PT-RS for each 4 OFDM symbols. On the other hand, since multi-level modulation such as 256 QAM has a small phase margin, the PT-RS is multiplexed every 1 OFDM symbol, that is, in consecutive OFDM symbols.

The information processing apparatus 10 controls the multiplexing method of CSI-RS and DM-RS according to whether Waveform is OFDMA or DFT-spread OFDM. In addition, the information processing apparatus 10 may adaptively control the multiplexing interval in the time domain of the PT-RS according to the measured phase noise and the modulation scheme (MCS).

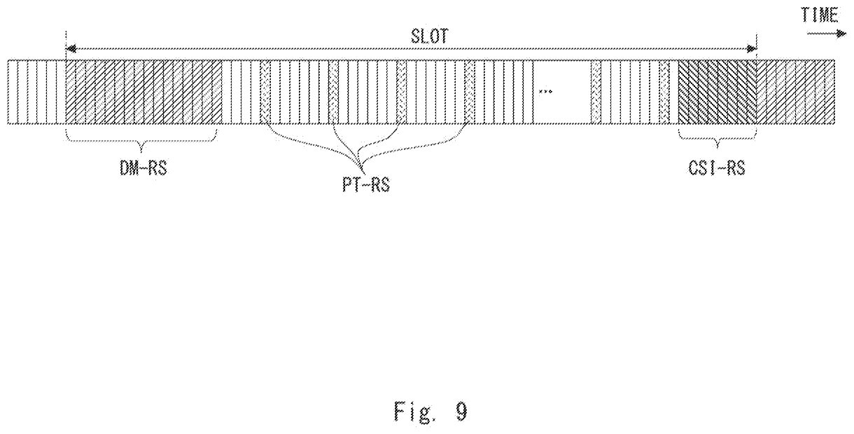

FIG. 9 is a diagram illustrating an example of the multiplexing method of the reference signal in the single-carrier FDMA according to the example embodiment. In the uplink of the NR wireless interface, OFDMA is adopted in the case of multi-antenna transmission (MIMO). Therefore, in the uplink of the NR wireless interface, the DM-RS and the sounding reference signal (SRS) for OFDMA are defined. DFT-spread ofdm, which is the single-carrier FDMA, is adopted in the 3GPP Release 15 specification by only one-stream transmission (SIMO). Therefore, the DM-RS and the SRS multiplexing method of DFT-spread OFDM in the uplink of LTE are applied. Therefore, in the NR wireless interface of the Release 15 specification, a new reference signal of DFT-spread OFDM is not defined.

The information processing apparatus 10 multiplexes the DM-RS into an N_{DM} symbol (single-carrier symbol) section at the head of the slot. The CSI-RS is multiplexed into an N_{CSI} symbol at the end of the slot every several slots or in the subsequent symbol section of the DM-RS at the head of the slot. On the other hand, the information processing apparatus 10 multiplexes the PT-RS into N_{PT} symbols consecutive to the information symbol section. N_{PT} is one or decimal (several symbols). The N_{PT} symbol block interval of the PT-RS is applied and controlled according to the frequency spectrum and MCS to be applied. As described above, the multiplexing method of the DM-RS of the present disclosure is different from the multiplexing method of the DM-RS of DFT-spread OFDM in the LTE uplink. On the other hand, the SRS of LTE is multiplexed into a fast Fourier transformation (FFT) block at the end of the subframe. Therefore, in the example of the present disclosure, in a case where the CSI-RS is multiplexed at the end of the slot every several slots, a configuration is the same as that of the multiplexing method of the SRS of LTE.

The PT-RS is not defined in the wireless interface of LTE. In single-carrier DFT-spread OFDM, an equalizer is essential to compensate for waveform distortion caused by multipath interference. In a case where time domain equalization (TDE) is used, N_{DM} requires a length several times longer than that of a transversal equalizer. In a case where frequency domain equalization (FDE) is used, N_{DM} is the length of the number of FFT stages. In the case of MIMO multiplexing using a plurality of transmission antennas, antenna-specific orthogonal CSI-RS and DM-RS are required. In the case of the CSI-RS, in general, an orthogonal reference signal is generated by preparing the number of symbols corresponding to the number of transmission antennas. Alternatively, there is also a method of performing spreading in the time domain on reference signals of the number of symbols corresponding to the number of transmission antennas by using orthogonal codes, and multiplexing in the code domain. In the DM-RS, the DM-RSs of the number of N_{DM} symbols per transmission antenna are prepared as many as the number of transmission antennas, and orthogonal DM-RSs are generated by TDM multiplexing. However, in a case where the DM-RSs corresponding to the number of transmission antennas are generated by TDM, necessary resources increase proportionally with the number of transmission antennas. In this regard, by performing Distributed FDM-multiplexing in the frequency domain, an orthogonal DM-RS in the frequency domain can be generated. Distributed FDM is a method of performing allocation into frequency components in a constant period in the frequency domain, and does not cause an increase in peak power. A method for generating a Distributed FDM signal in the frequency domain by repeatedly multiplexing symbol blocks in the time domain is proposed as Interleaved FDMA (IFDMA). In addition, it is possible to generate the Distributed FDM signal by using a method of converting the DM-RS of the N_{DM} symbol in the time domain into a frequency domain signal by DFT and performing discrete mapping to frequency component (subcarrier) positions at regular intervals in the frequency domain.

### Example of Adaptively Controlling Multiplexing Method of Control Information

The information processing apparatus 10 may adaptively control the multiplexing method of control information on the basis of the acquired information. The control information may be, for example, the control information of layer 1 or layer 2 such as resource allocation (grant) information, a modulation scheme, a transport block size, acknowledgement (Ack) of retransmission, and non-acknowledgement (Nack). The control information of layer 1 and layer 2 is necessary for demodulation and decoding of a shared channel for transmitting user information. Therefore, the control signal may be TDM-multiplexed at the head of the slot in both OFDMA and DFT-spread OFDM (single-carrier).

Note that, in the LTE and NR wireless interfaces, in the control information, a multiplexing method of control information of the layer 1 and the layer 2 of resource allocation (grant) information, a modulation scheme, a transport block size, and acknowledgement (Ack) of retransmission/non-acknowledgement (Nack) is determined by the number of transmission antennas.

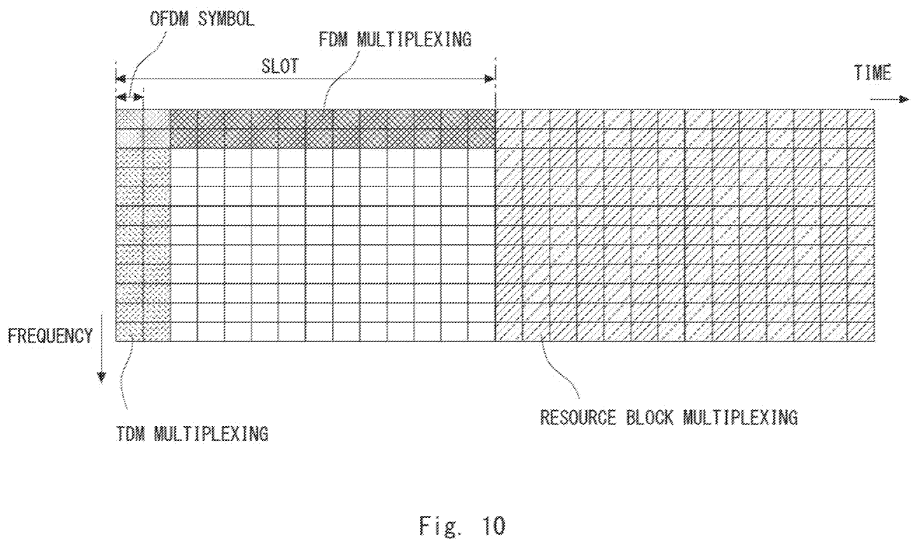

FIG. 10 is a diagram illustrating an example of processing of adaptively controlling the multiplexing method of the control information in a case where OFDMA according to the example embodiment is used. In the information processing apparatus 10, in a case where OFDMA is used, the information processing apparatus 10 may determine the multiplexing method of the control information according to, for example, the frequency spectrum used in the wireless communication, the size of each coverage area, the distance between base stations, the directional beam gain, the quality (for example, an error rate) required for the control information, and the like.

In this case, for example, the information processing apparatus 10 may select one mode from the following three modes of multiplexing methods. In a first mode, TDM multiplexing in which a control signal is multiplexed in a section of one or several OFDM symbols at the head of the slot is used. Note that, in the wireless interface of the downlink of LTE using OFDMA, control channels are multiplexed from the OFDM symbol at the head of the slot to a maximum 3 OFDM symbol position. Therefore, an example of TDM multiplexing of the present disclosure is similar to the LTE or NR wireless interface.

In a second mode, FDM multiplexing is performed at a preset subcarrier position. In the FDM multiplexing, for example, the control information is multiplexed on one or several subcarriers in a resource block. The FDM multiplexing can increase the transmission power of a specific subcarrier by changing the power allocation between subcarriers with respect to a constant transmission power of the base station 20 or the user terminal 30. By increasing the power of the subcarrier in which the control information is multiplexed, the reach distance of the radio wave can be increased, or high quality reception can be realized. In the case of FDM multiplexing, a processing delay is longer than that in the above-described TDM multiplexing. Note that, in the LTE and NR wireless interfaces, the control information of OFDMA is TDM multiplexing, and the FDM multiplexing of the control information is not defined.

In a third mode, resource block multiplexing in which the control information is multiplexed over the entire resource block of one slot is used to increase the reach distance of the control information or achieve high-quality reception. By performing repetition of the bit level or the symbol level, the required reception SNR for satisfying the error rate of request can be lowered. Alternatively, a low error rate can be realized for the same reception SNR. Ultra-low rate error correction coding (channel coding) may be used instead of bit or symbol repetition. Note that, in an uplink control channel (Physical Uplink Control Channel (PUCCH)) of the NR wireless interface, 0.08 (about 1/12, and note that, here, “/” represents a division) is adopted as the lowest channel coding rate. In addition, symbol repetition for improving the reception SNR is also adopted. In any method, the resource of a wireless section increases, and thus there is a difference from the NR wireless interface in that the resource of the entire resource block is allocated to the control information.

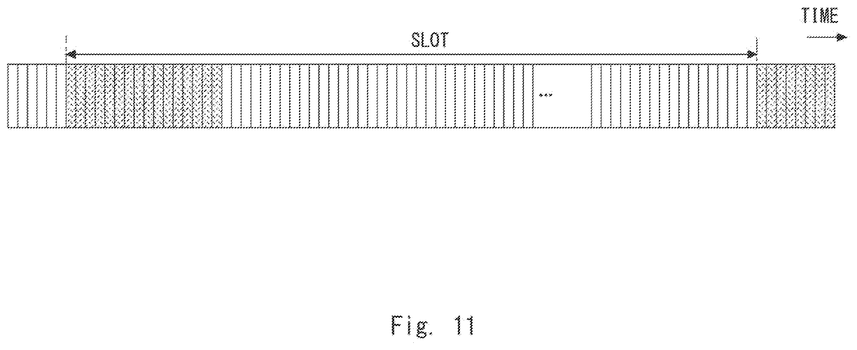

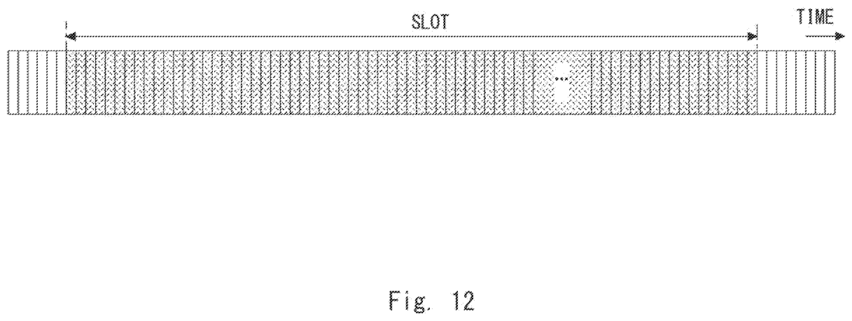

FIGS. 11 and 12 are diagrams illustrating an example of processing of adaptively controlling the multiplexing method of the control information in a case where DFT-spread OFDM according to the example embodiment is used. In a case where DFT-spread OFDM is used, the information processing apparatus 10 may determine the multiplexing method of the control information according to, for example, the frequency spectrum used in the wireless communication, the size of each coverage area, the distance between base stations, the directional beam gain, the quality (for example, an error rate) required for the control information, and the like.

In this case, for example, the information processing apparatus 10 may select one mode from the following two modes of multiplexing methods. In a first mode, as illustrated in FIG. 11, multiplexing is performed at one or several symbol positions at the head of the slot by TDM multiplexing. In a second mode, as illustrated in FIG. 12, by the resource block multiplexing, the control information is multiplexed on the entire resource block of one slot in order to increase the reach distance of the control information or realize the high-quality Similarly to the case of OFDMA, the required reception SNR for reception. satisfying the error rate of the request can be lowered by using bit level or symbol level repetition or ultra-low rate error correction coding (channel coding). Alternatively, a low error rate can be realized for the same reception SNR. Note that, as described above, in the NR wireless interface, DFT-spread OFDM is adopted only in the case of uplink one-stream transmission (SIMO without MIMO). Therefore, the control information multiplexing of DFT-spread OFDM is performed according to the definition of the control information multiplexing of the PUCCH of LTE. The PUCCH of LTE has a narrow band, and thus is configured such that frequency hopping is performed between two slots in one subframe. In addition, since the subframe length is as long as 1 ms, the control information from a plurality of users is CDMA-multiplexed by using a cyclic shift Zadoff-Chu sequence. The control information from different users is multiplexed in Zadoff-Chu sequences of different cyclic shift amounts. On the other hand, in the example of the present disclosure, the control information is TDM-multiplexed into the shared channel for transmitting the user information. In a case where DFT-spread OFDM is applied to the downlink, TDM multiplexing is performed in the shared channel in this manner. The same applies to a case where DFT-spread OFDM is applied to the uplink, but in a case where Ack/Nack information of a downlink shared channel (PDSCH) is transmitted in the uplink, when there is no user information to be transmitted to the buffer of the user terminal 30, the control information is multiplexed over the entire slots. In this case, symbol repetition or a low-rate channel coding rate is used. The transmission power can be reduced by multiplexing the control information resources over the entire slots.

### Example of Adaptively Controlling Symbol Interval and Roll-Off Rate of Raised Cosine Roll-Off Filter

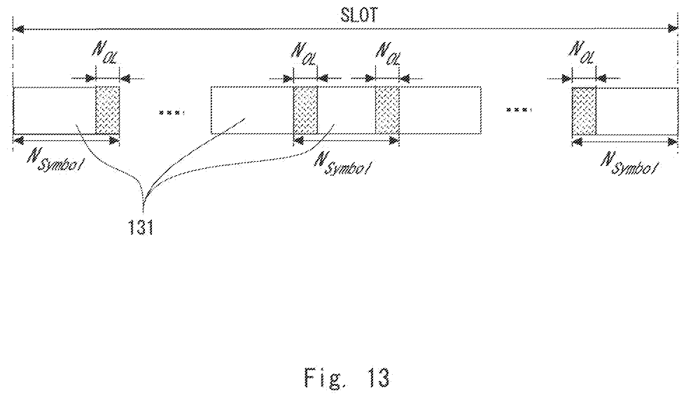

The information processing apparatus 10 may adaptively control the symbol interval and the roll-off rate of the raised cosine roll-off filter on the basis of the acquired information. FIG. 13 is a diagram illustrating an example of a transmission frame configuration in a case where Faster than Nyquist (FTN) according to the example embodiment is used. In FIG. 13, N_{symbol} represents the number of samples of the symbol, and N_{OL} represents the number of samples of an overlapping section. The transmission frame 131 in the case of using Faster-than-Nyquist (FTN) corresponds to a symbol of a single-carrier in the case of DFT-spread OFDM. In addition, the transmission frame 131 corresponds to an OFDM symbol per subcarrier in the case of OFDMA. By using FTN, symbols in the time domain can be overlapped and multiplexed at intervals shorter than the Nyquist interval. Therefore, since the number of multiplexed symbols per slot increases, the frequency utilization efficiency can be increased.

Note that Non Patent Literature 6 discloses that the Euclidean distance between signal points does not change even if an inter-symbol interval is shortened to 0.802 T with the Nyquist interval set to T. In a case where the inter-symbol interval is shortened to 0.802 T, the frequency utilization efficiency can be increased by about 25%. On the other hand, the PAPR depends on the waveform, the modulation scheme, the band limiting factor of the waveform shaping filter, and the like. In a practical system of wireless communication such as a cellular system, a root raised cosine filter (RRCF) is generally used as the waveform shaping filter. Since the RRCF approaches an ideal low-pass filter as the roll-off rate decreases (approaches 0), a steep attenuation characteristic can be realized in the frequency domain. Therefore, the occupied signal band in the system band (allocated band) can be increased. On the other hand, in the time domain waveform, amplitude variation increases, and a time range in which inter-symbol interference occurs increases. Therefore, the PAPR of the transmission signal increases as the roll-off rate decreases.

By using the FTN, the information processing apparatus 10 increases the symbol length without changing the number of symbols per slot. As the symbol length becomes longer, the subcarrier interval (interval of frequency components) becomes shorter. Therefore, in a case where the number of subcarriers (the number of frequency components) is the same, a signal occupied band can be narrowed. Therefore, since the roll-off rate for accommodating the frequency spectrum in the system band can be increased, the PAPR can be reduced. The information processing apparatus 10 may adaptively control the symbol interval and the roll-off rate of the RRCF according to, for example, the frequency spectrum used in the wireless communication, the size of each coverage area, the distance between base stations, the directional beam gain, the quality (for example, an error rate) required for the control information, and the like. For the back-haul link, in a case where the distance between base stations is longer than the threshold value, the information processing apparatus 10 may increase the roll-off rate by using FTN. Accordingly, for example, low PAPR is realized. On the other hand, for the back-haul link, in a case where the distance between base stations is not longer than the threshold value, the information processing apparatus 10 may multiplex symbols at the Nyquist interval without applying FTN. Accordingly, for example, the processing load in the base station 20 can be reduced.

### Resource Allocation of Access Link in Case Where Back-Haul Link and Access Link use Same Frequency Spectrum and IAB Node Performs Multi-Hop Communication

In the IAB, multi-hop is employed. Therefore, it is required to consider resource allocation in a plurality of IAB nodes in the case of multi-hop. In a case where different links are multiplexed in the TDM, a delay increases as the number of hops increases. For example, focusing on the access link between the IAB node and the user terminal 30, when the interval between the allocation slots of the downlink and the uplink becomes long, a round trip time (RTT) increases, and the delay of resource allocation and retransmission control increases. The same applies to the back-haul link. Therefore, it is required to consider the uplink and downlink slot allocations in each access link and back-haul link in consideration of the delay.

In addition, in a case where the TDM is applied, in a case of multi-hop, orthogonality of links at each IAB node is ensured, but it is required to consider resource allocation and transmission power control that reduce cross-link interference between the links of IAB nodes that are separated by the number of hops.

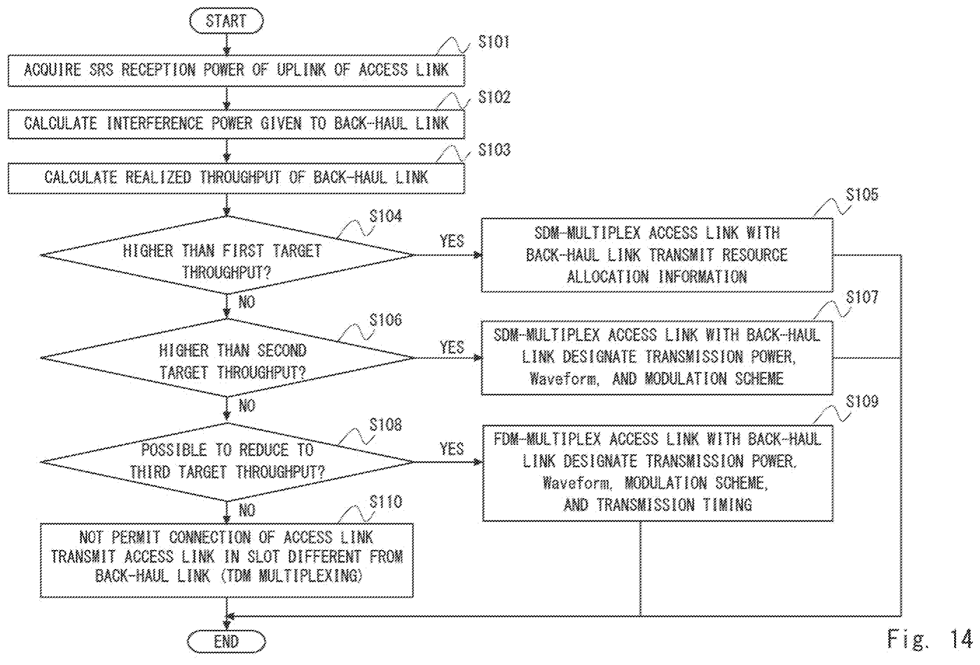

An example of uplink resource allocation processing of the access link in a case where the back-haul link and the access link use the same frequency spectrum and the IAB node (for example, the small cell base stations 20B and 20C) performs multi-hop communication will be described with reference to FIG. 14. FIG. 14 is a flowchart illustrating an example of uplink resource allocation processing of access links according to the example embodiment.

As illustrated in FIG. 14, in a case where the back-haul link and the access link use the same frequency spectrum and a plurality of small cell base stations perform multi-hop communication, the information processing apparatus 10 may determine whether or not to permit connection of the access link on the basis of the degree of interference between the back-haul link and the access link. In this case, the information processing apparatus 10 may calculate the degree of interference according to a radio signal from the user terminal 30 and the pattern of the directional beam transmitted from each base station 20. Then, in a case where the connection of the access link is permitted, the information processing apparatus 10 may transmit the uplink data of the access link from the user terminal 30 to the base station 20 by SDM or FDM for the back-haul link of one time slot.

Hereinafter, a more specific processing example will be described with reference to FIG. 14. Note that the IAB node preferentially connects a back-haul link with an IAB donor or an IAB node of a higher station and an IAB node of a lower station. The resource of the back-haul link with the higher station is allocated by the higher station. The IAB node allocates the resource used for the back-haul link with the lower station to the lower station. Each IAB node stores the positions of a plurality of IAB nodes of the higher station and the lower station. Then, each IAB node can determine the pattern (for example, a beam traveling direction, or the like) of a beam in a case where the plurality of IAB nodes of the higher station and the lower station perform directional beam transmission by a test at the time of base station installation or learning during operation. In this case, for each IAB node, three-dimensional (3D) directional beam control for controlling an elevation is used in addition to an azimuth by using a two-dimensional (2D) antenna arrangement.

In step S101, the information processing apparatus 10 acquires, from the IAB node, the reception power and the reception beam pattern of a radio signal from the uplink user terminal 30, and the reception beam pattern in a case where the plurality of IAB nodes of the higher station and the lower station perform the directional beam transmission. Here, the radio signal may be, for example, a scheduling request signal, a sounding reference signal (SRS), or the like.

Subsequently, the information processing apparatus 10 calculates interference power (an example of the “degree of interference”) given to the back-haul link by the access link (step S102). Here, the information processing apparatus 10 may calculate the correlation of each reception beam acquired in step S101. Then, the information processing apparatus 10 may calculate the interference power on the basis of the correlation between the reception beams and the reception power of the radio signal from the user terminal 30.

Subsequently, the information processing apparatus 10 calculates a realized throughput of the back-haul link according to the interference power given to the back-haul link by the access link (step S103). Then, the information processing apparatus 10 permits the connection of the access link in any one of the following modes according to the reduction amount (degradation amount) of the realized throughput of the back-haul link in a case where the user terminal 30 requests the connection in the uplink of the access link. First, the information processing apparatus 10 determines whether or not the realized throughput is higher than a first target throughput (step S104). In a case where the realized throughput is higher than the first target throughput (YES in step S104), the information processing apparatus 10 multiplexes the uplink of the access link with the back-haul link by SDM (step S105), and ends the processing. Here, the information processing apparatus 10 performs resource allocation for access link connection, that is, access link uplink. Then, the information processing apparatus 10 transmits resource allocation information (grant) from the IAB node to the user terminal 30. This is, for example, a situation in which the access link can be orthogonalized with the back-haul link by SDM by beamforming.

On the other hand, in a case where the realized throughput is not higher than the first target throughput (NO in Step S104), the information processing apparatus 10 determines whether or not the realized throughput is higher than the second target throughput lower than the first target throughput (Step S106). In a case where the realized throughput is higher than the second target throughput (YES in step S106), the information processing apparatus 10 multiplexes the uplink of the access link with the back-haul link by SDM (step S107), and ends the processing. Here, for example, the information processing apparatus 10 may determine various parameters including the transmission power of the user terminal 30, the waveform, the modulation scheme, and the like on the basis of the information acquired by the acquisition unit 11. In this case, the information processing apparatus 10 may determine various parameters on the basis of, for example, the distance between the IAB node and the user terminal 30, the estimated value of the phase noise, the PAPR, and the like. In this case, for example, the information processing apparatus 10 may calculate a reduction amount in the transmission power of the user terminal 30 at which the realized throughput can realize the first target throughput. Then, the information processing apparatus 10 may cause the IAB node to notify the user terminal 30 of the determined various parameters on a downlink control channel. Accordingly, for example, the highest substantial throughput can be realized in the uplink of the access link of the user terminal 30.

On the other hand, in a case where the realized throughput is not higher than the second target throughput (NO in Step S106), the information processing apparatus 10 determines whether or not the throughput of the back-haul link can be reduced to a third target throughput lower than the second target throughput (Step S108). In a case where the throughput can be reduced to the third target throughput (YES in step S108), the information processing apparatus 10 reduces the throughput of the back-haul link, FDM-multiplexes the uplink of the access link with the back-haul link in the same slot (step S109), and ends the processing. Here, for example, the information processing apparatus 10 may determine various parameters including the transmission power of the user terminal 30, the waveform, the modulation scheme, the transmission timing of the transmission signal from the user terminal 30, and the like on the basis of the information acquired by the acquisition unit 11. In this case, the information processing apparatus 10 may determine various parameters on the basis of, for example, the distance between the IAB node and the user terminal 30, the estimated value of the phase noise, the PAPR, and the like. Then, the information processing apparatus 10 may cause the IAB node to notify the user terminal 30 of the determined various parameters on a downlink control channel. Accordingly, for example, the highest substantial throughput can be realized in the access link of the user terminal 30.

On the other hand, in a case where the throughput of the back-haul link cannot be reduced to the third target throughput (NO in step S108), the information processing apparatus 10 causes the IAB node to reject (not permit) the connection of the access link by the user terminal 30 (step S110), and ends the processing. Here, the information processing apparatus 10 may allocate a time slot different from the back-haul link to the uplink of the access link. Accordingly, the uplink of the access link is TDM-multiplexed with the back-haul link.

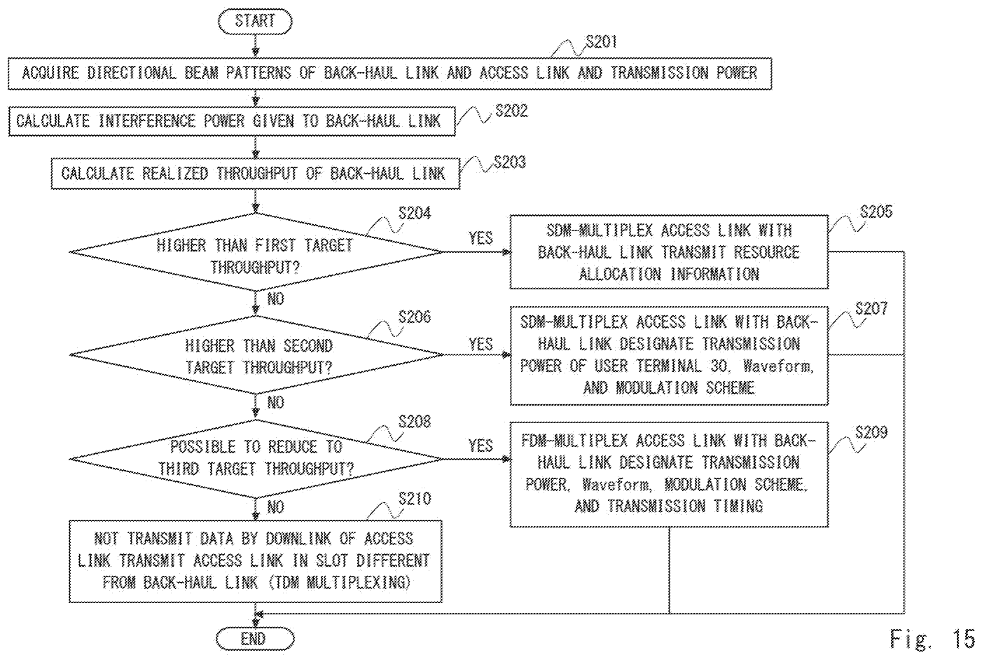

Next, an example of downlink resource allocation processing of the access link in a case where the back-haul link and the access link use the same frequency spectrum and the IAB node (for example, the small cell base stations 20B and 20C) performs multi-hop communication will be described with reference to FIG. 15. FIG. 15 is a flowchart illustrating an example of downlink resource allocation processing of access links according to the example embodiment.

As illustrated in FIG. 15, in a case where the back-haul link and the access link use the same frequency spectrum and a plurality of small cell base stations perform multi-hop communication, the information processing apparatus 10 may calculate the degree of interference between the back-haul link and the access link. In this case, for example, the information processing apparatus 10 may calculate the degree of interference on the basis of the pattern of the directional beam transmitted from each base station 20. Then, the information processing apparatus 10 may determine whether or not to permit connection of the access link of the user terminal 30 on the basis of the calculated degree of interference.

Then, in a case where the connection of the access link by the user terminal 30 is permitted, the information processing apparatus 10 may transmit the uplink data of the access link from the base station 20 to the user terminal 30 by SDM or FDM for the back-haul link of one time slot.

Hereinafter, a more specific processing example will be described with reference to FIG. 15. Note that, as described above, the IAB node preferentially connects the back-haul link with the IAB donor or the IAB node of the higher station and the IAB node of the lower station. Note that, transmission to the IAB node of the higher station and the IAB node of the lower station may be performed in the same slot or in different slots.

In step S201, the information processing apparatus 10 acquires the directional beam patterns of the back-haul link and the access link and the transmission power. Subsequently, the information processing apparatus 10 calculates interference power between beams given to the back-haul link by the access link on the basis of the information acquired in step S201 (step S202). Subsequently, the information processing apparatus 10 calculates a realized throughput of the back-haul link according to the interference power given to the back-haul link by the access link (step S203).

Then, the information processing apparatus 10 permits the connection of the access link in any one of the following modes according to the reduction amount (degradation amount) of the realized throughput of the back-haul link in a case where the access link is connected to the user terminal 30. First, the information processing apparatus 10 determines whether or not the realized throughput is higher than the first target throughput (step S204). In a case where the realized throughput is higher than the first target throughput (YES in step S204), the information processing apparatus 10 multiplexes the downlink of the access link with the back-haul link by SDM (step S205), and ends the processing. Here, the information processing apparatus 10 performs transmission of the downlink of the access link, that is, resource allocation for the access link to the user terminal 30. This is, for example, a situation in which the access link can be orthogonalized with the back-haul link by SDM by beamforming.

On the other hand, in a case where the realized throughput is not higher than the first target throughput (NO in Step S204), the information processing apparatus 10 determines whether or not the realized throughput is higher than the second target throughput lower than the first target throughput (Step S206). In a case where the realized throughput is higher than the second target throughput (YES in step S206), the information processing apparatus 10 multiplexes the downlink of the access link with the back-haul link by SDM (step S207), and ends the processing. Here, for example, the information processing apparatus 10 may determine various parameters including the transmission power from the IAB node to the user terminal 30, the waveform, the modulation scheme, and the like on the basis of the information acquired by the acquisition unit 11. In this case, the information processing apparatus 10 may determine various parameters on the basis of, for example, the distance between the IAB node and the user terminal 30, the PAPR, the estimated value of the phase noise, the PAPR, and the like. In this case, for example, the information processing apparatus 10 may calculate the transmission power, at which the realized throughput can realize the first target throughput, from the IAB node to the user terminal 30. Then, the information processing apparatus 10 may notify the IAB node of the determined various parameters and cause the IAB node to set the parameters. Accordingly, for example, the highest substantial throughput can be realized in the downlink of the access link.

On the other hand, in a case where the realized throughput is not higher than the second target throughput (NO in Step S206), the information processing apparatus 10 determines whether or not the throughput of the back-haul link can be reduced to the third target throughput lower than the second target throughput (Step S208). In a case where the throughput can be reduced to the third target throughput (YES in step S208), the information processing apparatus 10 reduces the throughput of the back-haul link, performs FDM multiplexing on the access link in the same slot as the back-haul link (step S209), and ends the processing. Here, for example, the information processing apparatus 10 may determine various parameters including the transmission power from the IAB node to the user terminal 30, the waveform, the modulation scheme, the transmission timing of the transmission signal from the user terminal 30, and the like on the basis of the information acquired by the acquisition unit 11. In this case, the information processing apparatus 10 may determine various parameters on the basis of, for example, the distance between the IAB node and the user terminal 30, the estimated value of the phase noise, the PAPR, and the like. Then, the information processing apparatus 10 may cause the IAB node to notify the user terminal 30 of the determined various parameters on a downlink control channel. Accordingly, for example, the highest substantial throughput can be realized in the downlink of the access link of the user terminal 30.

On the other hand, in a case where the throughput of the back-haul link cannot be reduced to the third target throughput (NO in step S208), the information processing apparatus 10 does not transmit the downlink of the access link by the user terminal 30 to the IAB node (step S210), and ends the processing. Here, the information processing apparatus 10 may allocate a time slot different from the back-haul link to the downlink of the access link. Accordingly, the downlink of the access link is TDM-multiplexed with the back-haul link.

Next, a modified example of the example embodiment of the present disclosure will be described. The following modified examples may be implemented by appropriately combining with the example embodiment of the present disclosure.

### First Modification

The information processing apparatus 10 may be an apparatus included in one housing, but the information processing apparatus 10 of the present disclosure is not limited thereto. Each unit of the information processing apparatus 10 may be implemented by, for example, cloud computing including one or more computers. In addition, the information processing apparatus 10 may be a server or an edge server that realizes network functions virtualization (NFV). In addition, at least a part of the processing of each unit of the information processing apparatus 10 may be executed by the base station 20 or the user terminal 30. Such an information processing apparatus 10 is also included in an example of the “information processing apparatus” of the present disclosure.

### Second Modification

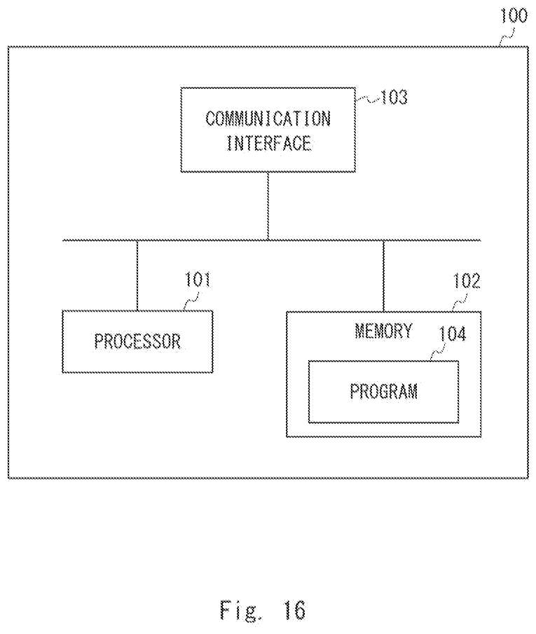

FIG. 16 is a diagram illustrating an example of a configuration in a case where the information processing apparatus 10 is implemented by a computer and a program. In the example of FIG. 16, the information processing apparatus 10 (computer 100) includes a processor 101, a memory 102, and a communication interface 103. These units may be connected by a bus or the like. The memory 102 stores at least a part of the program 104. The communication interface 103 includes an interface necessary for communication with other network elements. In the case of the base station 20, the communication interface 103 includes, for example, an interface for communication with the user terminal 30 via one or more antennas, an interface for communication between base stations, an interface for communication with various servers on the core network side, and the like.

When the program 104 is executed by the processor 101, the memory 102, and the like in cooperation with each other, at least a part of the processing of the example embodiment of the present disclosure is performed by the computer 100. The memory 102 may be of any type suitable for a local technology network. The memory 102 may be a non-transitory computer-readable storage medium, as a non-limiting example. The memory 102 may also be implemented using any suitable data storage technology, such as semiconductor-based memory devices, magnetic memory devices and systems, optical memory devices and systems, fixed memory and removable memory, and the like. Although only one memory 102 is illustrated in the computer 100, there may be several physically different memory modules in the computer 100. The processor 101 may be of any type. The processor 101 may include one or more of a general purpose computer, a special purpose computer, a microprocessor, a digital signal processor (DSP), and a processor based on a multi-core processor architecture as a non-limiting example. The computer 100 may have multiple processors, such as an application specific integrated circuit chip that is temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, microprocessor or other computing device.

The present disclosure also provides at least one computer program product tangibly stored on a non-transitory computer-readable storage medium. The computer program product includes computer-executable instructions, such as those included in a program module, and executes on a device on the subject real or virtual processor to perform the processes or methods of the present disclosure. Program modules include routines, programs, libraries, objects, classes, components, data structures, and the like that execute particular tasks or implement particular abstract data types. The functionality of the program modules may be combined or divided between the program modules as desired in various example embodiments. The machine-executable instructions of the program module can be executed in a local or distributed device. In a distributed device, program modules can be located on both local and remote storage media.

Program code for executing the methods of the present disclosure may be written in any combination of one or more programming languages. These program codes are provided to a processor or controller of a general purpose computer, dedicated computer, or other programmable data processing apparatus. When the program code is executed by a processor or controller, the functions/acts in the flowcharts and/or the implementing block diagrams are performed. The program code executes entirely on the machine, partly on the machine, as a stand-alone software package, partly on the machine, partly on a remote machine, or entirely on the remote machine or server.

The program can be stored and supplied to the computer using various types of non-transitory computer readable media. Non-transitory computer readable media include various types of tangible storage media. Examples of the non-transitory computer readable medium include a magnetic recording medium, a magneto-optical recording medium, an optical disc medium, a semiconductor memory, and the like. The magnetic recording medium includes, for example, a flexible disk, a magnetic tape, a hard disk drive, and the like. The magneto-optical recording medium includes, for example, a magneto-optical disk and the like. The optical disc medium includes, for example, a Blu-ray disc, a compact disc (CD)-read only memory (ROM), a CD-recordable (R), a CD-rewritable (RW), and the like. The semiconductor memory includes, for example, a solid state drive, a mask ROM, a programmable ROM (PROM), an erasable PROM (EPROM), a flash ROM, a random access memory (RAM), and the like. In addition, the program may be supplied to the computer using various types of transitory computer readable media. Examples of the transitory computer readable media include electrical signals, optical signals, and electromagnetic waves. The transitory computer readable media can supply the programs to the computer via wired or wireless communication paths such as wires and optical fiber.

Note that the present invention is not limited to the example embodiments explained above and can be changed as appropriate without departing from the scope of the present invention.

A portion or all of the example embodiments described above can be described as in the following supplementary notes but the present invention is not limited to the following notes.

### Supplementary Note 1

An information processing apparatus including:
an acquisition means for acquiring
   information regarding wireless communication of a back-haul link between a first base station and a second base station and
   information regarding wireless communication of an access link between the second base station and a user terminal;
a control means for determining a first wireless communication method of the back-haul link and a second wireless communication method of the access link on the basis of the information acquired by the acquisition means; and
a transmission means for transmitting information indicating the first wireless communication method determined by the control means to at least one of the first base station or the second base station, and transmitting information indicating the second wireless communication method to at least one of the second base station or the user terminal.

### Supplementary Note 2

The information processing apparatus according to Supplementary Note 1, in which the information regarding the wireless communication of the back-haul link includes information indicating at least one of a frequency spectrum which is able to be used in wireless communication, a size of each coverage area, a distance between base stations, a distribution of traffic of each coverage area, a peak-to-average power ratio of a transmission signal, phase noise, or a power delay profile of each of the first base station and the second base station.

### Supplementary Note 3

The information processing apparatus according to Supplementary Note 1 or 2, in which the information regarding the wireless communication of the access link includes information indicating at least one of a frequency spectrum which is able to be used for wireless communication, a size of each coverage area, a peak-to-average power ratio of a transmission signal, a phase noise, or a power delay profile of the second base station, or a moving speed of the user terminal.

### Supplementary Note 4

The information processing apparatus according to any one of Supplementary Notes 1 to 3, in which the control means determines at least one of a physical channel multiplexing scheme, a set of coding rates of channel coding, or a set of signal space arrangements of mapping bits after channel coding of at least one of the back-haul link or the access link on the basis of the information acquired by the acquisition means.

### Supplementary Note 5

The information processing apparatus according to any one of Supplementary Notes 1 to 4, in which the control means determines at least one of a reference signal multiplexing method, a control signal multiplexing method, a symbol interval of a transmission signal, or a roll-off rate of a root raised cosine filter of at least one of the back-haul link or the access link on the basis of the information acquired by the acquisition means.

### Supplementary Note 6

The information processing apparatus according to any one of Supplementary Notes 1 to 5, in which
the control means
   in a case where the back-haul link and the access link use the same frequency spectrum and a plurality of small cell base stations perform multi-hop communication, determines whether to permit connection of the access link or not on the basis of a degree of interference, which is according to a radio signal from the user terminal and a pattern of a directional beam transmitted from each base station, between the back-haul link and the access link, and
   in a case where the connection of the access link is permitted, transmits uplink data of the access link from the user terminal forming the access link to a base station by space-division multiplexing or frequency-division multiplexing on the back-haul link of one time slot.

### Supplementary Note 7

The information processing apparatus according to any one of Supplementary Notes 1 to 6, in which
the control means
   in a case where the back-haul link and the access link use the same frequency spectrum and a plurality of small cell base stations perform multi-hop communication, determines whether to permit connection of the access link or not on the basis of a degree of interference, which is according to a pattern of a directional beam transmitted from each small cell base station, between the back-haul link and the access link, and
   in a case where the connection of the access link is permitted, transmits uplink data of the access link from a base station forming the access link to the user terminal by space-division multiplexing or frequency-division multiplexing on the back-haul link of one time slot.

### Supplementary Note 8

An information processing method including:
acquiring first information regarding wireless communication of a back-haul link between a first base station and a second base station;
acquiring second information regarding wireless communication of an access link between the second base station and a user terminal;
determining a first wireless communication method of the back-haul link and a second wireless communication method of the access link on the basis of the first information and the second information;
transmitting information indicating the first wireless communication method to at least one of the first base station or the second base station; and
transmitting information indicating the second wireless communication method to at least one of the second base station or the user terminal.

### Supplementary Note 9

The information processing method according to Supplementary Note 8, in which the first information regarding the wireless communication of the back-haul link includes information indicating at least one of a frequency spectrum which is able to be used in wireless communication, a size of a coverage area, a distance between base stations, a distribution of traffic in the coverage area, a peak-to-average power ratio of a transmission signal, phase noise, and a power delay profile of each of the first base station and the second base station.

### Supplementary Note 10

The information processing method according to Supplementary Note 8 or 9, in which the second information regarding the wireless communication of the access link includes information indicating at least one of a frequency spectrum which is able to be used in wireless communication, a size of a coverage area, a peak-to-average power ratio of a transmission signal, a phase noise, or a power delay profile of the second base station, or a moving speed of the user terminal.

### Supplementary Note 11

The information processing method according to any one of Supplementary Notes 8 to 10, in which at least one of a physical channel multiplexing scheme, a set of coding rates of channel coding, or a set of signal space arrangements of mapping bits after channel coding of at least one of the back-haul link or the access link is determined on the basis of the first information and the second information.

### Supplementary Note 12

The information processing method according to any one of Supplementary Notes 8 to 11, in which at least one of a reference signal multiplexing method, a control signal multiplexing method, a symbol interval of a transmission signal, or a roll-off rate of a root raised cosine filter of at least one of the back-haul link or the access link is determined on the basis of the first information and the second information.

### Supplementary Note 13

A non-transitory computer readable medium having stored therein a program for causing an information processing apparatus to execute:
processing of acquiring first information regarding wireless communication of a back-haul link between a first base station and a second base station;
processing of acquiring second information regarding wireless communication of an access link between the second base station and a user terminal;
processing of determining a first wireless communication method of the back-haul link and a second wireless communication method of the access link on the basis of the first information and the second information;
processing of transmitting information indicating the first wireless communication method to at least one of the first base station or the second base station; and
processing of transmitting information indicating the second wireless communication method to at least one of the second base station or the user terminal.

### Supplementary Note 14

A wireless communication system including:
a first base station: a second base station: a user terminal;
an acquisition means for acquiring
   information regarding wireless communication of a back-haul link between the first base station and the second base station and
   information regarding wireless communication of an access link between the second base station and the user terminal;
a control means for determining a first wireless communication method of the back-haul link and a second wireless communication method of the access link on the basis of the information acquired by the acquisition means; and
a transmission means for transmitting information indicating the first wireless communication method determined by the control means to at least one of the first base station or the second base station, and transmitting information indicating the second wireless communication method to at least one of the second base station or the user terminal.

### Supplementary Note 15

The wireless communication system according to Supplementary Note 14, in which the information regarding the wireless communication of the back-haul link includes information indicating at least one of a frequency spectrum which is able to be used in wireless communication, a size of each coverage area, a distance between base stations, a distribution of traffic of each coverage area, a peak-to-average power ratio of a transmission signal, phase noise, or a power delay profile of each of the first base station and the second base station.

This application claims priority based on Japanese Patent Application No. 2021-100001 filed on Jun. 16, 2021, and the entire disclosure thereof is incorporated herein.

### REFERENCE SIGNS LIST

1 WIRELESS COMMUNICATION SYSTEM
10 INFORMATION PROCESSING APPARATUS
11 ACQUISITION UNIT
12 CONTROL UNIT
13 TRANSMISSION UNIT
20 BASE STATION
30 USER TERMINAL

What is claimed is:

1. An information processing apparatus comprising:
at least one memory storing instructions, and
at least one processor configured to execute the instructions to;
acquire
information regarding wireless communication of a back-haul link between a first base station and a second base station and
information regarding wireless communication of an access link between the second base station and a user terminal;
determine a first wireless communication method of the back-haul link and a second wireless communication method of the access link on a basis of the acquired information; and
transmit information indicating the determined first wireless communication method to least one of the first base station or the second base station, and transmitting information indicating the second wireless communication method to at least one of the second base station or the user terminal.

2. The information processing apparatus according to claim 1, wherein the information regarding the wireless communication of the back-haul link includes information indicating at least one of a frequency spectrum which is able to be used in wireless communication, a size of each coverage area, a distance between base stations, a distribution of traffic of each coverage area, a peak-to-average power ratio of a transmission signal, phase noise, or a power delay profile of each of the first base station and the second base station.

3. The information processing apparatus according to claim 1, wherein the information regarding the wireless communication of the access link includes information indicating at least one of a frequency spectrum which is able to be used for wireless communication, a size of each coverage area, a peak-to-average power ratio of a transmission signal, a phase noise, or a power delay profile of the second base station, or a moving speed of the user terminal.

4. The information processing apparatus according to claim 1, wherein the at least one processor is configured to determine at least one of a physical channel multiplexing scheme, a set of coding rates of channel coding, or a set of signal space arrangements of mapping bits after channel coding of at least one of the back-haul link or the access link on a basis of the acquired information.

5. The information processing apparatus according to claim 1, wherein the at least one processor is configured to determine at least one of a reference signal multiplexing method, a control signal multiplexing method, a symbol interval of a transmission signal, or a roll-off rate of a root raised cosine filter of at least one of the back-haul link or the access link on a basis of the acquired information.

6. The information processing apparatus according to claim 1, wherein
the at least one processor is configured to
in a case where the back-haul link and the access link use the same frequency spectrum and a plurality of small cell base stations perform multi-hop communication, determine whether to permit connection of the access link or not on a basis of a degree of interference, which is according to a radio signal from the user terminal and a pattern of a directional beam transmitted from each base station, between the back-haul link and the access link, and
in a case where the connection of the access link is permitted, transmit uplink data of the access link from the user terminal forming the access link to a base station by space-division multiplexing or frequency-division multiplexing on the back-haul link of one time slot.

7. The information processing apparatus according to claim 1, wherein
the at least one processor is configured to
in a case where the back-haul link and the access link use the same frequency spectrum and a plurality of small cell base stations perform multi-hop communication, determine whether to permit connection of the access link or not on a basis of a degree of interference, which is according to a pattern of a directional beam transmitted from each small cell base station, between the back-haul link and the access link, and
in a case where the connection of the access link is permitted, transmit uplink data of the access link from a base station forming the access link to the user terminal by space-division multiplexing or frequency-division multiplexing on the back-haul link of one time slot.

8. An information processing method comprising:
acquiring first information regarding wireless communication of a back-haul link between a first base station and a second base station;
acquiring second information regarding wireless communication of an access link between the second base station and a user terminal;
determining a first wireless communication method of the back-haul link and a second wireless communication method of the access link on a basis of the first information and the second information;
transmitting information indicating the first wireless communication method to at least one of the first base station or the second base station; and
transmitting information indicating the second wireless communication method to at least one of the second base station or the user terminal.

9. The information processing method according to claim 8, wherein the first information regarding the wireless communication of the back-haul link includes information indicating at least one of a frequency spectrum which is able to be used in wireless communication, a size of a coverage area, a distance between base stations, a distribution of traffic in the coverage area, a peak-to-average power ratio of a transmission signal, phase noise, and a power delay profile of each of the first base station and the second base station.

10. The information processing method according to claim 8, wherein the second information regarding the wireless communication of the access link includes information indicating at least one of a frequency spectrum which is able to be used in wireless communication, a size of a coverage area, a peak-to-average power ratio of a transmission signal, a phase noise, or a power delay profile of the second base station, or a moving speed of the user terminal.

11. The information processing method according to claim 8, wherein at least one of a physical channel multiplexing scheme, a set of coding rates of channel coding, or a set of signal space arrangements of mapping bits after channel coding of at least one of the back-haul link or the access link is determined on a basis of the first information and the second information.

12. The information processing method according to claim 8, wherein at least one of a reference signal multiplexing method, a control signal multiplexing method, a symbol interval of a transmission signal, or a roll-off rate of a root raised cosine filter of at least one of the back-haul link or the access link is determined on a basis of the first information and the second information.

13. (canceled)

14. A wireless communication system comprising:
a first base station; a second base station; a user terminal;
at least one memory storing instructions, and
at least one processor configured to execute the instructions to;
acquire
information regarding wireless communication of a back-haul link between the first base station and the second base station and
information regarding wireless communication of an access link between the second base station and the user terminal;
determine first wireless communication method of the back-haul link and a second wireless communication method of the access link on a basis of the acquired information; and
transmit information indicating the determined first wireless communication method to at least one of the first base station or the second base station, and transmitting information indicating the second wireless communication method to at least one of the second base station or the user terminal.

15. The wireless communication system according to claim 14, wherein the information regarding the wireless communication of the back-haul link includes information indicating at least one of a frequency spectrum which is able to be used in wireless communication, a size of each coverage area, a distance between base stations, a distribution of traffic of each coverage area, a peak-to-average power ratio of a transmission signal, phase noise, or a power delay profile of each of the first base station and the second base station.

16. A method for a user terminal comprising:
connecting with a first base station via an access link; and
receiving information indicating a wireless communication method of the access link determined based on first information on a wireless communication between the first base station and a second base station connected via backhaul link, and second information on a wireless communication between the first base station and the user terminal connected via the access link.
